(19) United States
(12) Patent Application Publication
(10) Pub. No.: US 2007/0081839 A1
(43) Pub. Date: Apr. 12, 2007

(54) Toner conveying unit and electrophotographic image forming apparatus using the conveying unit

(75) Inventors: Hye-young Min, Metropolitan-city (KR); Yong-sung Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/501,731

(22) Filed: Aug. 10, 2006

(30) Foreign Application Priority Data
Oct. 12, 2005 (KR) 10-2005-0096195

(51) Int. Cl. G03G 21/00

(52) U.S. Cl. 399/358

(57) ABSTRACT

A toner conveying unit and an electrophotographic image forming apparatus having the toner conveying unit are provided. The electrophotographic image forming apparatus temporarily stores a toner image on a photoreceptor in an image forming process and forms an image by transferring the toner image of an image receptor onto a sheet of paper. The toner conveying unit includes: a duct connecting a first point and a second point in the electrophotographic image forming apparatus; a conveying belt located in the duct and includes a plurality of protrusions for effectively conveying toner along a length of the duct; and a support member which is located at the inside of the conveying belt to prevent or inhibit the conveying belt from curving.

### CROSS-REFERENCE TO RELATED PATENT APPLICATION

This application claims the benefit of Korean Patent Application No. 10-2005-0096195, filed on Oct. 12, 2005, in the Korean Intellectual Property Office, the disclosure of which is hereby incorporated by reference in its entirety.

### BACKGROUND OF THE INVENTION

1. Field of the Invention

The present invention relates to a toner conveying unit and an electrophotographic image forming apparatus having the toner conveying unit. More particularly, the invention is directed to a toner conveying unit having an improved structure to prevent a conveying belt from loosening.

2. Description of the Related Art

In an electrophotographic image forming apparatus, light corresponding to image data is irradiated onto a uniformly charged photoconductor by an exposing unit to form an electrostatic latent image on the photoconductor. A developing unit forms a toner image by supplying toner onto the electrostatic latent image. In a color electrophotographic image forming apparatus, four developing units are usually required, which store different colored toners such as cyan C, magenta M, yellow Y, and black K toners. The toner image is transferred directly onto a printing medium from the photoconductor or via an intermediate transfer medium. When the printing medium passes through a fixing unit, the toner image is fixed onto the printing medium by heat and pressure. Toner which remains on the photoconductor or the intermediate transfer medium after the toner image is transferred onto the printing medium is removed and stored in a storage container. In order to convey the removed toner into the storage container, the electrophotographic image forming apparatus includes a toner conveying unit.

FIG. 1 is a schematic view of a conventional toner conveying unit 80.

Toner T removed by a cleaning unit 10 from the photoconductor or the intermediate transfer medium flows into a duct 30. In the duct 30, one side of a conveying belt 60 contacts a rotating driving axle 40, and the other side of the conveying belt 60 contacts a driven axle 50. The driving axle 40 is located near the cleaning unit 10 and rotates so that the lower side 60b of the conveying belt 60 can move from an inlet 20 to an outlet 70. The toner T entering the duct 30 through the inlet 20 is conveyed to the outlet 70 along with the movement of the lower side 60b of the conveying belt 60. The toner T discharged through the outlet 70 is stored in a storage container 90.

FIG. 2 shows a problem in the conventional toner conveying unit 80.

The upper side of the conveying belt 60 is pulled by the rotation of the driving axle 40, and therefore has a tension side 60a, tightened by the tension produced from the driving axle 40. The lower side of the conveying belt 60 is pushed by the rotation of the driving axle 40, and is therefore a release side 60b, loosened by the absence of tension. The release side 60b easily curves and rolls around the driving axle 40, and the toner T may accumulate at the curved portion of the release side 60b. The accumulated toner T increases resistance and prevents the conveying belt 60 from easily conveying the toner T.

This problem may be solved to some extent by reversing the driving axle 40 and the driven axle 50 so that the tension side 60a and the release side 60b are reversed. In this case, however, the toner T may still accumulate due to a structural failure of the duct 30. Furthermore, the toner T may not be effectively conveyed due to the flexibility of the conveying belt 60. As mentioned above, the conventional toner conveying unit 80 cannot easily convey the toner T, since the conveying belt 60 is easily curved.

### SUMMARY OF THE INVENTION

The present invention provides a toner conveying unit having a conveying belt that can aid toner conveying by preventing the toner conveying belt from curving. The invention is also directed to an electrophotographic image forming apparatus having the toner conveying unit.

According to an aspect of the present invention, a toner conveying unit for an electrophotographic image forming apparatus is provided which temporarily stores a toner image on a photoreceptor in an image forming process and forms an image by transferring the toner image of an image receptor onto a sheet of paper. The apparatus comprises: a duct connecting one point and another point in the electrophotographic image forming apparatus; a conveying belt which is located in the duct and provides a plurality of protrusions for effectively conveying toner; and a support member which is located at the inside of the conveying belt to prevent the conveying belt from curving.

According to another aspect of the present invention, an electrophotographic image forming apparatus is provided which temporarily stores a toner image on a photoreceptor in an image forming process and forms an image by transferring the toner image of an image receptor onto a sheet of paper. The apparatus comprises a toner conveying unit, the toner conveying unit including: a duct connecting one point and another point in the electrophotographic image forming apparatus; a conveying belt which is located in the duct and having a plurality of protrusions for effectively conveying toner; and a support member which is located at the inside of the conveying belt to prevent the conveying belt from curving.

These and other aspects of the invention will become apparent from the following detailed description of the invention, which taken in conjunction with the annexed drawings, disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a conventional toner conveying unit;

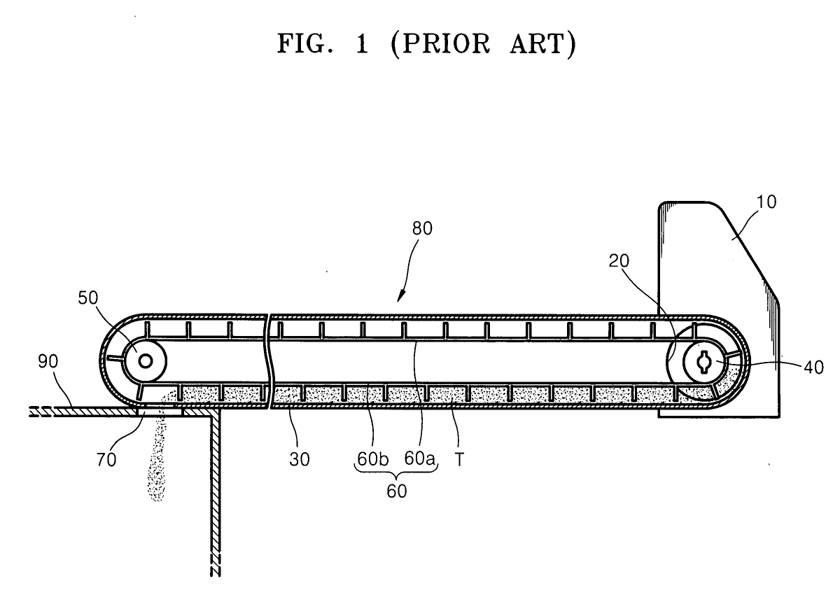

FIG. 2 shows a problem in the conventional toner conveying unit;

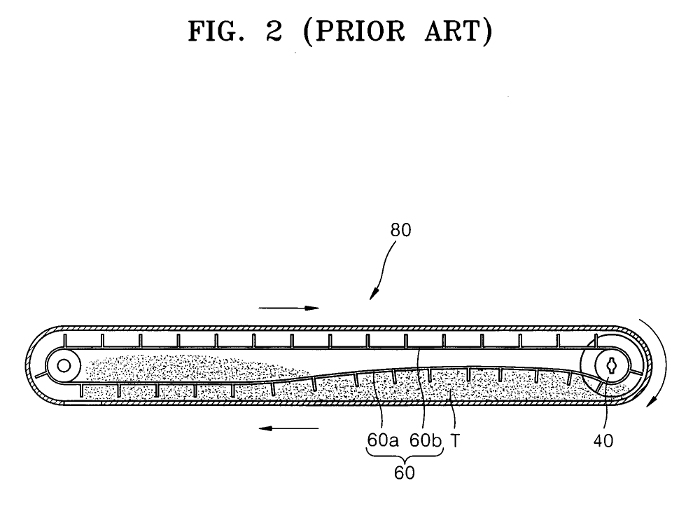

FIG. 3 is a schematic view of the structure of an electrophotographic image forming apparatus having a toner conveying unit according to an embodiment of the present invention;

FIG. 4 is an exploded perspective view of the toner conveying unit according to an embodiment of the present invention; and

FIGS. 5A to 5C are sectional views of a toner conveying unit according to an embodiment of the present invention.

### DETAILED DESCRIPTION OF THE INVENTION

Exemplary embodiments of a toner conveying unit and an electrophotographic image forming apparatus having the toner conveying unit of the present invention will now be described in detail with reference to the accompanying drawings. Like numeral references denotes like elements in the drawings, and the size and thickness of elements may be exaggerated for clarity.

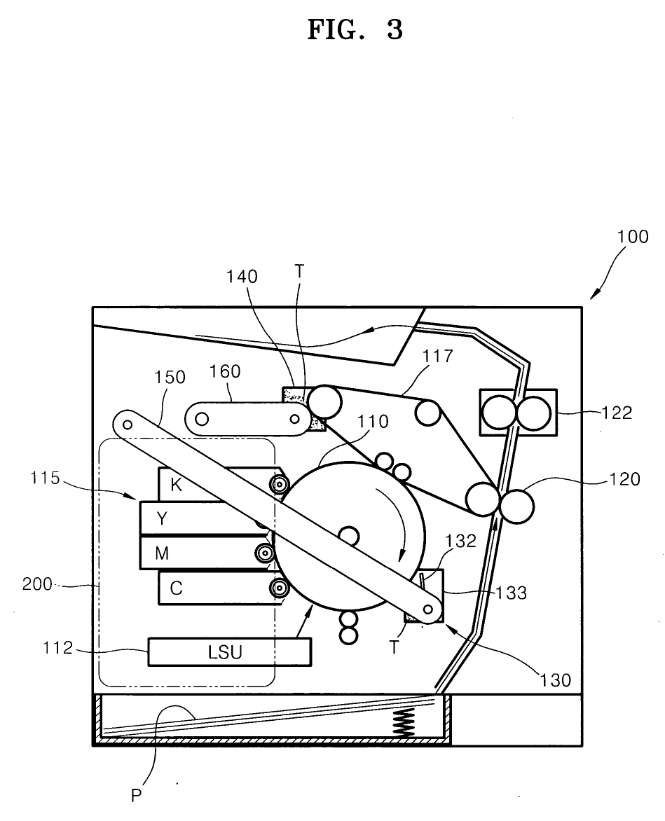

FIG. 3 is a schematic view of the structure of an electrophotographic image forming apparatus according to an embodiment of the present invention. An electrophotographic image forming apparatus 100 includes a photoconductive drum 110, an exposing unit 112, a developing unit 115, a transfer belt 117, a transfer roller 120, and a fixing unit 122.

The photoconductive drum 110 is an example of a photoreceptor, in which a photoconductive layer is formed on the surface of a metal drum. The exposing unit 112 forms an electrostatic latent image by irradiating light corresponding to image data onto the photoconductive drum 110, which is charged to a uniform electric potential. A laser scanning unit (LSU) using a laser diode light source is commonly used as the exposing unit 112.

The developing unit 115, which includes four developing units 115C, 115M, 115Y, and 115K which respectively store colored toners such as cyan C, magenta M, yellow Y, and black K powder toner, forms a toner image by supplying the toner onto the electrostatic latent image formed on the photoconductive drum 110.

The transfer belt 117 is an example of an intermediate transfer medium which receives the toner image from the photoconductive drum 110 and transfers the toner image onto a printing medium P. The C, M, Y, and K toner images are sequentially formed on the photoconductive drum 110, and sequentially transferred and superimposed onto the transfer belt 117 to form a color toner image.

The transfer roller 120 faces the transfer belt 117. When the color toner image is transferred onto the transfer belt 117, the transfer roller 120 is separated from the transfer belt 117. The color toner image is completely transferred onto the transfer belt 117, and the transfer roller 120 contacts the transfer belt 117 to transfer the color toner image onto the printing medium P. The printing medium P having the toner image passes through the fixing unit 122, and the toner image is fixed onto the printing medium P by heat and pressure.

The operations for forming an image in the electrophotographic image forming apparatus 100 having the aforementioned structure will be described.

Color image data consists of C, M, Y, and K data. The color toner images are superimposed onto the transfer belt 117 in the order of C, M, Y, and K, and are transferred onto the printing medium P, thereby forming a color image.

When a light signal corresponding to cyan C image data is irradiated onto the photoconductive drum 110 which is charged to a uniform electric potential by the exposing unit 112, the electric potential decreases where the light strikes. Thus, the electric potential becomes different between the light irradiated portion and the other portions, thereby forming the electrostatic latent image on the photoconductive drum 110. When the photoconductive drum 110 rotates and the electrostatic latent image approaches the developing unit 115C, the cyan C toner stored in the developing unit 115C is attached onto the electrostatic latent image, thereby forming a cyan C toner image. When the cyan C toner image approaches the transfer belt 117 by the rotation of the photoconductive drum 110, the toner image is transferred onto the transfer belt 117 by an electric potential difference with the transfer belt 117 and a contact pressure. When the C toner image is completely transferred onto the transfer belt 117, M, Y, and K toner images of M, Y, and K are also transferred and superimposed onto the transfer belt 117 through the same process, thereby forming the color toner image. When the printing medium P passes between the transfer belt 117 and the transfer roller 120, the color toner image is transferred onto the printing medium P. The fixing unit 122 fixes the color toner image onto the printing medium P by heat and pressure and discharges the printing medium P, thereby completing the color image forming.

The photoconductive drum 110 and the transfer belt 117 are image receptors which temporarily store the toner image before the toner image is transferred onto the printing medium P. When the toner image is transferred onto the photoconductive drum 110, transfer belt 117, and the printing medium P, some of the toner T remains on the photoconductive drum 110 or the transfer belt 117. Before the next printing operation, the toner T remaining on the image receptors 110 and 117 must be removed from the image receptors 110 and 117.

The electrophotographic image forming apparatus 100 includes a first cleaning unit 130 which removes the remaining toner T from the photoconductive drum 110, and a second cleaning unit 140 which removes the remaining toner T from the transfer belt 117. The toner T removed from the first cleaning unit 130 and the second cleaning unit 140 is conveyed into a storage container 200 by toner conveying units 150 and 160. When the storage container 200 is full, it is separated from the image forming apparatus 100 to be discarded. When a color image forming apparatus is used, the toner T cannot be reused since the colored toners are mixed with each other. However, in a monochrome image forming apparatus, the toner T can be reused and the removed toner T flows back into the developing unit 115. If the toner T is reused, the toner conveying unit may be connected with a toner container supplying the toner T onto the developing unit 115, instead of the storage container 200.

The electrophotographic image forming apparatus 100 of the present embodiment uses the toner conveying units 150 and 160 which convey the removed toner T, but this is only an exemplary embodiment. Thus, the toner conveying unit may be used to convey the toner T from one point to another in the electrophotographic image forming apparatus 100 in another embodiment. For example, the toner conveying unit may be used to convey the toner T from the toner container to the developing unit 115 when the developing unit 115 and the toner container are separate, or to convey the toner T within the developing unit 115. Based on where the toner conveying unit is located, its inlet, outlet, or driving source may be different. However, those skilled in the art will understand such differences as simple changes in design. Therefore, the present invention will be described in detail hereinafter in terms of the toner conveying unit 150 located between the first cleaning unit 130 and the storage container 200.

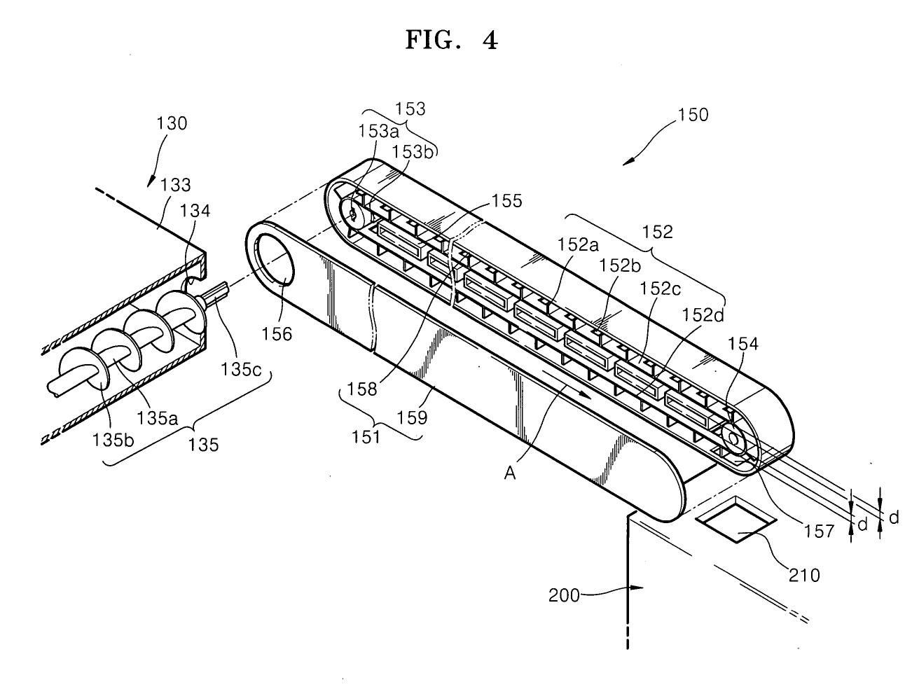

FIG. 4 is an exploded perspective view of the toner conveying unit 150 according to an embodiment of the present invention.

The first cleaning unit 130 includes a blade (shown by the reference numeral 132 in FIG. 3), a waste-toner storage 133, a discharge hole 134, and an auger 135.

The blade 132 contacts the photoconductive drum (shown by the reference numeral 110 in FIG. 3) and scrapes off the toner T. The removed toner T is temporarily stored in the waste-toner storage 133. The auger 135 includes a shaft 135a and a spiral wing 135b formed around the shaft 135a. The auger 135 is an example of a conveying element which pushes the toner T from the waste-toner storage 133 to the discharge hole 134.

Through the discharge hole 134, the toner T is discharged from the first cleaning unit 130 and conveyed into the storage container 200 by the toner conveying unit 150.

The toner conveying unit 150 includes a duct 151, a conveying belt 152, a driving axle or shaft 153, a driven axle or shaft 154, and a support member 155. In the embodiment, the axles include pulleys or rollers that support the conveying belt. As shown, the conveying belt 150 forms a loop having upper and lower portions that extend a substantial portion of the length of the duct 151.

The duct 151 includes a frame 158 and a cover 159 which covers the frame 158.

The driving axle 153 is located at one end of the frame 158. A connection portion 153a is located at the center of the driving axle 153 in order to receive a driving force.

The driven axle 154 is rotatable and located at the other side of the frame 158.

A plurality of projections 152a are located on the outer surface of the conveying belt 152 in order to effectively convey the toner T along the length of the belt and the duct.

The conveying belt 152 contacts the driving axle 153 and the driven axle 154 and moves along with the rotation of the driving axle 153.

The conveying belt 152 and the driving axle 153 include anti-sliding members 152b and 153b which engage each other to prevent the conveying belt 152 from sliding or slipping over the driving axle 153 when the driving axle 153 rotates. For example, a plurality of notches 152b may be located on the inner surface of the conveying belt 152, and a plurality of protrusions 153b may be located on the outer surface of the driving axle 153 and engage with the notches 152b. In this case, the anti-sliding members are the notches 152b and the protrusions 153b. The notches 152b have a though-hole shape.

The conveying belt 152 is a sheet of flexible material such as synthetic resin, synthetic rubber, or a compound of both. Examples of the synthetic resin include polycarbonate (PC) resin, and relatively flexible polyvinylidene fluoride sheet.

An inlet 156 of the duct 151 is located near the first end of the duct and the driving axle 153 and an outlet 157 is located at the second end of the duct and the driven axle 154.

The inlet 156 allows the toner T to enter the duct. The inlet faces the connection portion 153a of the driving axle 153 of the cover 159. The outlet 157 which allows the toner T to be discharged from the duct is located at the lower side near the driven axle 154 of the frame 158.

The inlet 156 faces the discharge hole 134 of the first cleaning unit 130. A sealing member (not shown) may be located where the inlet 156 and the discharge hole 134 are connected, in order to prevent the toner T from leaking out.

The driving axle 153 and the auger 135 are connected through the inlet 156 and the discharge hole 134, and have a common axis.

An end portion 135c of the auger 135 extends from the shaft 135a and extends outward from the first cleaning unit 130. The end portion 135c engages the driving axle 153, so that the driving force of the auger 135 can be transferred to the driving axle 153. A coupling may be located between the auger 135 and the driving axle 153.

The driving force is transferred from the auger 135 to the driving axle 153 in the present embodiment, but a gear may be located between the auger 135 and the driving axle 153 in another embodiment. A separate driving unit may be used to transfer the driving force to the toner conveying unit 150 in other embodiment. In this case, the inlet 156 may be located in another place. For example, the inlet 156 may be located near the driven axle 154, and the outlet 157 may be located near the driving axle 153.

The toner conveying unit 150 is located such that the outlet 157 faces an inlet or injection hole 210 of the storage container 200.

The toner conveying unit 150 of the present embodiment is located such that the toner T discharged from the outlet 157 falls directly into the storage container 200 as shown in FIG. 4, but this is only an exemplary embodiment. Thus, an inclined passage may be located between the outlet 157 and the injection hole 210 in another embodiment. Further, a cap may be provided at the end of the passage to prevent the toner T from leaking out when the storage container 200 is detached.

In addition, the outlet 157 is located at the lower side of the frame 158 in the present embodiment, but the outlet 157 may be located at a side surface of the frame 158 in another embodiment. In this case, additional conveying members may be located between the outlet 157 and the injection hole 210, so that the toner T can be readily discharged into the storage container 200.

The support member 155 prevents or inhibits the conveying belt 152 from curving when conveying the toner throughout the duct. The support member 155 is located at the inside of the conveying belt 152 such that the conveying belt surrounds the support member 155. The support member 155 may be separated or spaced from the inner surface of the conveying belt 152 to prevent friction between the inner surface of the conveying belt 152 and the support member 155 and to aid conveying. In addition, the support member 155 may be located near the driving axle 153 in order to prevent the conveying belt 152 from rolling around the driving axle 153.

The support member 155 is located and extends between the driving axle 153 and the driven axle 154. The support member 155 may be a single pillar or support having a long flat side extending between the axles or a plurality of pillars or supports arranged side-by-side and closely spaced together to minimize deflection of the conveying belt.

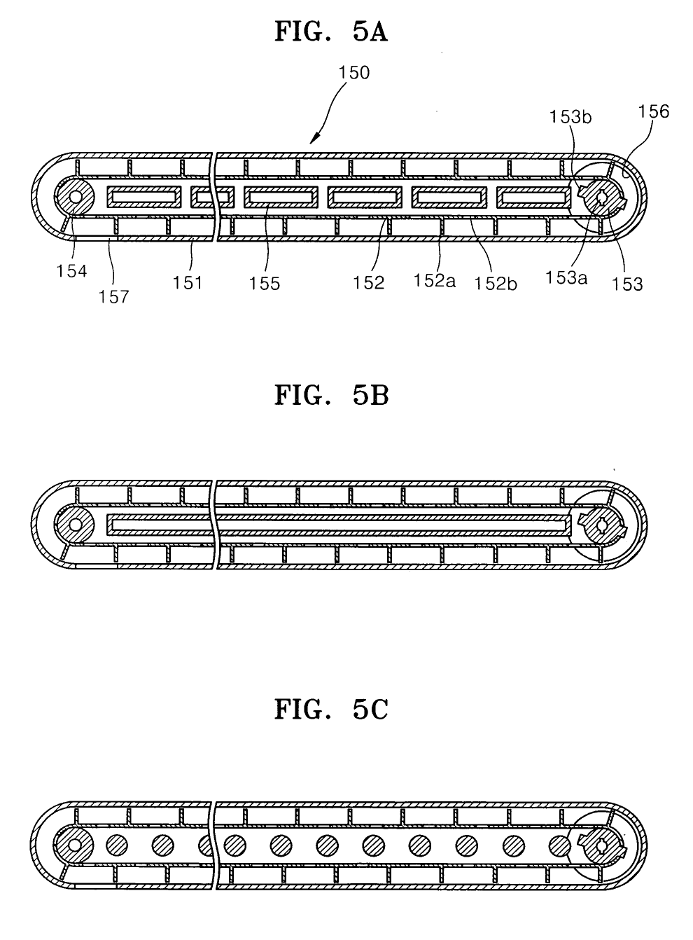

As shown in FIGS. 5A to 5C, the cross section of the support member 155 may be rectangular or circular. In addition, the support member 155 may be one or form a plurality of hollow shaped pillars. In one embodiment of the invention, the support member has at least one flat surface that extends a substantial portion of the duct between the first and second end thereof and is substantially parallel to an inner surface of the lower portion of the belt.

The support member 155 may be molded or formed as part of the frame 158, or may be a separate member attached to the frame 158. When the frame 158 is made of plastic, integral molding is preferable.

Referring now to FIG. 4, the operation of the toner conveying units 150 will be described.

When the auger 135 rotates, the toner T, which has been pushed by the auger 135 through the discharge hole 134 and the inlet 156, flows into the duct 151.

The conveying belt 152 moves along with the rotation of the driving axle 153 by a driving force of the auger 135, and conveys the toner T through the duct 151 from the inlet at the first end towards the outlet 157 at the second end of the duct.

In this embodiment of the present invention, since the notches 152b (anti-sliding members) formed on the conveying belt 152 are through-holes, the minute toner T on upper side 152c of the conveying belt 152 drops down through the notches 152b. The lower side 152d of the conveying belt 152 moves in a direction A from the inlet 156 to the outlet 157. As a result, the toner T is conveyed, while being pushed by projections 152a located at the lower side 152d of the conveying belt 152.

In this case, the upper side 152c of the conveying belt 152 is a tension side which is pulled by the rotation of the driving axle 153, and the lower side 152d of the conveying belt 152 is a release side which is pushed by the rotation of the conveying belt 152. The release side 152d may easily curve or roll around the driving axis 153 since the release side 152d is loosened in the absence of tension. The support member 155 of the present invention prevents or inhibits the flexing, curving and rolling of the belt along the lower portion between the axles. If the notches 152b are not through-holes, the toner T may be conveyed to the upper side 152c of the conveying belt 152. In this case, the driving axle 153 rotates in the reverse direction to that described above.

Since the support member 155 is located inside of the conveying belt 152, the conveying belt 152 has less free space at its inside. As a result, the amount of the toner T which is not conveyed at the inside of the conveying belt 152 is reduced, thereby facilitating toner conveying.

The toner T conveyed towards the outlet 157 by the conveying belt 152 is discharged into the storage container 200 through the outlet 157.

Accordingly, a toner conveying unit and an electrophotographic image forming apparatus having the toner conveying unit of the present invention can aid toner conveying by preventing toner from being snagged during conveying when a conveying belt is curved or the toner accumulates.

While the present invention has been particularly shown and described with reference to exemplary embodiments thereof, it will be understood by those skilled in the art that various changes in form and detail may be made therein without departing from the spirit and scope of the present invention as defined by the appended claims.

What is claimed is:

1. A toner conveying unit for an electrophotographic image forming apparatus which temporarily stores a toner image on a photoreceptor in an image forming process and forms an image by transferring the toner image from an image receptor onto a sheet of paper, the toner conveying unit comprising:
a duct connecting a first point and a second point in the electrophotographic image forming apparatus;
a conveying belt located in the duct and having a plurality of protrusions for effectively conveying toner along a length of said duct; and
a support member located inside of the conveying belt to prevent or inhibit the conveying belt from curving.

2. The toner conveying unit of claim 1, further comprising two axles contacting the conveying belt, wherein an inlet and an outlet of the duct are respectively located near the axles.

3. The toner conveying unit of claim 2, wherein the axles located near the inlet is a driving axle, and the driving axle rotates so that a lower side portion of the conveying belt between the axles moves from the inlet to the outlet.

4. The toner conveying unit of claim 1, wherein the electrophotographic image forming apparatus further comprises a cleaning unit for removing toner remaining on the image receptor and a storage container for storing the removed toner, and where the duct connects the cleaning unit and the storage container.

5. The toner conveying unit of claim 4, further comprising a driving axle and a driven axle supporting the conveying belt, wherein
the cleaning unit comprises an auger for pushing the removed toner, and the driving axle is connected with the auger to receive a driving force from the auger.

6. The toner conveying unit of claim 5, wherein the inlet of the duct faces a connection portion of the driving axle, and the driving axle and the auger have a common axis.

7. The toner conveying unit of claim 6, wherein the outlet of the duct is located at a lower side near the driven axle.

8. The toner conveying unit of claim 5, wherein the driving axle rotates so that a lower side portion of the conveying belt between the axles moves from the inlet to the outlet.

9. The toner conveying unit of claim 1, further comprising a driving axle and a driven axle contacting the conveying belt, wherein
the conveying belt and the driving axle comprise anti-sliding members which engage with each other so that the conveying belt does not slide over the driving axle when the driving axle rotates.

10. The toner conveying unit of claim 1, wherein the support member is spaced from the inner surface of the conveying belt.

11. The toner conveying unit of claim 1, wherein the support member consists of one or more hollow shaped pillars.

12. The toner conveying unit of claim 1, wherein the conveying belt is made of a synthetic resin sheet, synthetic rubber sheet, or synthetic resin and synthetic rubber mixture.

13. The toner conveying unit of claim 1, wherein the support member has a bottom surface substantially parallel to an inside surface of said conveying belt.

14. The toner conveying unit of claim 1, wherein said belt has a first end at a first end of said duct and a second end at a second end of said duct, and where said support member extends between said first and second ends of said duct.

15. The toner conveying unit of claim 14, wherein said support member comprises a plurality of spaced-apart rods.

16. The toner conveying unit of claim 14, wherein the support member has a flat surface extending substantially parallel to an inside bottom portion of said belt extending between said first and second ends of said duct.

17. The toner conveying unit of claim 14, wherein the support member comprises a plurality of spaced-apart members having a flat surface substantially parallel to an inside bottom portion of said belt and extending between said first and second ends of said belt.

18. An electrophotographic image forming apparatus which temporarily stores a toner image on a photoreceptor in an image forming process and forms an image by transferring the toner image of an image receptor onto a sheet of paper, the image forming apparatus comprising:
a toner conveying unit including a duct connecting a first point and a second point in the electrophotographic image forming apparatus, a conveying belt located in the duct and having a plurality of protrusions for effectively conveying toner along a length of the duct, and a support member located at an inner surface of the conveying belt to prevent or inhibit the conveying belt from curving.

19. The electrophotographic image forming apparatus of claim 18, further comprising:
a cleaning unit removing toner remaining on the image receptor; and
a storage container storing the removed toner;
wherein the duct connects the cleaning unit and the storage container.

20. The electrophotographic image forming apparatus of claim 19, wherein the cleaning unit comprises an auger pushing the removed toner toward the duct, and wherein the toner conveying unit comprises a driving axle and a driven axle supporting the conveying belt, and the driving axle being connected with the auger to receive a driving force from the auger.

21. The electrophotographic image forming apparatus of claim 20, wherein an inlet of the duct faces a connection portion of the driving axle, and the driving axle and the auger have a common axis.

22. The electrophotographic image forming apparatus of claim 21, wherein the outlet of the duct is located at a lower side near the driven axle of the duct.

23. The electrophotographic image forming apparatus of claim 20, wherein the driving axle rotates so that a lower side portion of the conveying belt between the axles moves from the inlet to the outlet.

24. The electrophotographic image forming apparatus of claim 18, wherein the support member is spaced from the inner surface of the conveying belt.

25. The electrophotographic image forming apparatus of claim 18, wherein the support member has one or more hollow shaped pillars.

26. The electrophotographic image forming apparatus of claim 18, wherein the conveying belt extends between a drive pulley and an idle pulley, and where the support member is surrounded by the conveying belt and a bottom surface facing an inside lower portion of the conveying belt.

27. The electrophotographic image forming apparatus of claim 26, wherein the support member comprises a plurality of supports spaced apart along said lower portion of said conveying belt.

28. The electrophotographic image forming apparatus of claim 27, wherein the supports are rod-shaped.

29. The electrophotographic image forming apparatus of claim 27, wherein each of said supports have a flat surface substantially parallel with said lower portion of said conveying belt.
